(19) United States
(12) Patent Application Publication
(10) Pub. No.: US 2004/0098482 A1
(43) Pub. Date: May 20, 2004

(54) Hub unit for preventing the spread of viruses, method and program therefor

(75) Inventor: Osamu Asano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/706,954

(22) Filed: Nov. 14, 2003

(30) Foreign Application Priority Data
Nov. 19, 2002 (JP) 2002-335409

(51) Int. Cl. G06F 15/173

(52) U.S. Cl. 709/225; 709/224

(57) ABSTRACT

The invention provides a hub unit that prevents the spread of viruses in a communications network. A hub unit connected to a plurality of communication devices, which controls transmission and reception of data between the devices, comprises: a first memory unit storing virus pattern information; a second memory unit temporarily storing data received from any one of the communication devices; a virus detecting unit that determines whether the data temporarily stored in the second memory unit is infected with a virus or not by comparing the virus patterns stored in the first memory unit with the data temporarily stored in the second memory unit; a virus spreading preventing unit that disables transmission of the data outside the hub unit when the detecting unit determines that the data is infected with a virus; and a third memory unit storing transmission MAC addresses of the plurality of communication devices connected to the hub. The virus spreading preventing unit determines whether or not a transmission address of a communication device, attached to the data, coincides with an MAC address stored in the second memory unit, when the detecting unit determines that data is infected with a virus, and if it determines that there is a coincidence between the two addresses, it disables transmission of data to a communication device transmitted the data infected with a virus and having the same address.

### BACKGROUND OF THE INVENTION

1. Field of the Invention

The present invention relates to a hub unit for preventing the spread of viruses in a communications network, a method and program therefor.

2. Description of the Related Art

Recently, data communication between computers or cellular phones via a communications network such as the internet has been utilized as communication technology advances. Computer viruses are known which enter into a computer connected to such network and destroy data in the computer and/or remove the data with malicious intent. In particular, since secret information is stored in computers in companies, it has become an essential subject for the companies to provide a countermeasure against the viruses. Accordingly, a system, for example a firewall, has been introduced that protects a host computer in a company, connected to an internet or an intranet, from being infected with viruses from the outside.

One of the measures for preventing virus infection, in the prior art, is a virus check network disclosed in the Japanese Patent Publication No. H11-167487 and is described below.

In the previous virus check network, whenever a new virus is detected, a software called Vaccine, for preventing the virus infection, must be updated in each computer connected to a network. This update must be completely done in all of the computers by the users, which is difficult and inefficient to accomplish.

Therefore, the disclosed virus check network was provided in order to allow the users to update the software efficiently. The virus check network includes a virus check device, a client terminal and a virus information monitor. The virus check device includes a virus pattern storing means, a virus check means for checking whether or not a received packet is infected with a virus, based on virus patterns, in the network and a means for transmitting a packet infected with a virus including a bit indicating that the packet is infected with a virus. The client terminal includes a means for detecting an infected packet based on the bit and a control means for making files, related to the infected packet, invalid. The virus information monitor includes a means for distributing virus pattern information to the virus check devices by multicasting, namely the means transmits the information to the multiple check devices at one time, and a means for carrying out unitary management of the virus pattern information.

Another measure for preventing virus infection in prior art is disclosed in the Japanese Patent Publication No. H10-307776 and is described below.

According to this measure, a reception-side device connected to a computer network is designed so as not to receive communication data infected with computer viruses to thereby prevent the device being infected with viruses beforehand. For this purpose, a system is provided that monitors received data to determine whether the data includes a computer virus or not. The system includes a means for receiving data via a computer network, a means for diagnosing whether received data is infected with a virus or not, a first transmission means for transmitting a signal indicating that the data is infected with a virus to the reception-side device when the diagnostic means determines that the data is infected with a virus and a second transmission means for transmitting received data when the diagnostic means determines that the data is not infected with a virus. Therefore, the reception-side device does not receive data infected with any virus.

The details of the former measure are described in “Scope of Claim for Patent”, claims 1 and 10, and “Detailed Description of the Invention”, paragraphs 0005 to 0012, in the specification, and the drawings, FIG. 1 of JPP No. H11-167487.

The details of the latter measure are described in “Scope of Claim for Patent”, claims 1 and 3, and “Detailed Description of the Invention”, paragraphs 0004 to 0014, in the specification, and the drawings, FIG. 1 of JPP No. H10-307776.

In the virus check network disclosed in the JPP No. H11-167487, in order to prevent client terminals from being infected with viruses, it is indispensable to provide a measure against viruses. The measure includes at least a virus checker that sets a bit indicating whether a transmitted packet is infected with a virus or not and client terminals each preventing the virus invasion to the terminal in accordance with the bit state. Therefore, all of the client terminals must be provided with a virus invasion preventive measure.

On the other hand, in the system disclosed in the JPP No. H10-307776, it is indispensable to provide a measure against viruses. The measure includes a monitor determining whether received data is infected with a computer virus or not and reception-side devices each designed not to receive communication data infected with the computer virus.

According to the prior art, all of computers must be provided with a means for excluding data infected with a virus. It is difficult to completely accomplish this.

### SUMMARY OF THE INVENTION

Accordingly, the object of the present invention is to solve the above-mentioned problems and to provide a hub unit for preventing the spread of viruses in a communications network, and to provide a method and programs therefor. The hub unit prevents viruses from invading computers that receive data in the network without complete provision of a measure in all of the computers which prevents viruses from invading the computers and prevents a secondary infection.

In order to solve the above problems, according to the present invention, a hub unit is provided which is connected to a plurality of communication devices, which controls transmission and reception of data between the devices, comprising: a first memory unit storing virus pattern information; a second memory unit temporarily storing data received from any one of the communication devices; a virus detecting unit that determines whether the data temporarily stored in the second memory unit is infected with a virus or not based on the virus patterns stored in the first memory unit; and a virus spreading preventing unit that disables transmission of the data outside the hub unit when the detecting unit determines that the data is infected with a virus.

The above hub unit further comprises a third memory unit storing transmission addresses of the plurality of the communication devices, wherein when the detecting unit determines that data is infected with a virus, the virus spreading preventing unit registers a transmission address of a communication device that transmitted the data to the hub unit.

In the hub unit, the virus spreading preventing unit disables transmission of newly received data from a first communication device of which transmits data infected with a virus, to the other communication devices, after the detecting unit determines that the data transmitted from the first communication device is infected with a virus.

In the hub unit, the virus spreading preventing unit disables reception of new data from a first communication device which transmits data infected with a virus, after the detecting unit determines that the data transmitted from the first communication device is infected with a virus.

In the hub unit, the virus spreading preventing unit invalidates data newly received from a first communication device which transmits data infected with a virus, after the detecting unit determines that the data transmitted from the first communication device is infected with a virus.

The above hub unit further comprises a display unit for notifying that data is infected with a virus if the detecting unit determines that the data is infected with a virus.

Accordingly, the object of the present invention is to solve the above-mentioned problems and to provide a system for preventing the spread of viruses in a communications network, comprising at least a hub unit connected to a plurality of communication devices, which controls transmission and reception of data between the devices and a monitor connected to the hub unit via the network, which monitors communication between the devices, wherein said monitor comprises: a first memory unit storing virus pattern information, a second memory unit temporarily storing data received from any one of the communication devices, and a virus detecting unit that compares virus patterns stored in the first memory unit with the data temporarily stored in the second memory unit, and determines whether the data is infected with a virus or not, and said hub unit comprises: a third memory unit storing transmission addresses of the plurality of the communication devices, and a virus spreading preventing unit that receives a transmission address of a communication device that transmitted data to the hub unit when the detecting unit determines that the data is infected with a virus, and disables transmission of the data to communication devices other than the communication device that transmitted the data infected with the virus.

In the above system, the virus spreading preventing unit determines whether or not a transmission address of a communication device, attached to data transmitted from the device, coincides with an address stored in the third memory unit, when the virus detecting unit determines that the data is infected with a virus and, if it determines that there is a coincidence between the two addresses it disables transmission of the data to a communication device having the same address.

In the above system, the virus spreading preventing unit disables reception of data newly transmitted from the communication device which transmits data infected with a virus, after the detecting unit determines that the data is infected with the virus.

In the above system, the virus spreading preventing unit invalidates data newly received from the communication device which transmits data infected with a virus, after the detecting unit determines that the data is infected with the virus.

The above system further comprises a display unit for notifying that data is infected with a virus when the detecting unit determines that the data is infected with the virus.

In the above system, a plurality of hub units are connected in a cascade form and said virus spreading preventing unit determines whether or not a transmission address of a communication device, attached to data transmitted from the device, coincides with an address stored in the third memory unit in a first hub unit among the plurality of the hub units, when the virus detecting unit determines that the data is infected with a virus, and if it determines that there is no coincidence between the two addresses it successively checks for coincidence between the transmission address and addresses stored in the respective third memory units in the successive hub units, and if it determines that there is a coincidence between two addresses it disables transmission of the data to a communication device having the same address.

In the above system, the monitor may be a gateway.

In the above system, the monitor may be a router.

### BRIEF DESCRIPTION OF THE DRAWINGS

FIG. 1 is a drawing showing a general structure of a hub unit having a function of preventing the spread of viruses according to a first embodiment of the present invention;

FIG. 2 is a drawing showing a first example of a hub unit according to the present invention;

FIG. 3 is a drawing showing a second example of a hub unit according to the present invention;

FIG. 4 is a drawing showing a third example of a hub unit according to the present invention;

FIG. 5 is a time chart showing a link pulse and communication data;

FIG. 6 is a block diagram showing a structure of a system for preventing the spread of viruses according to a second embodiment of the present invention; and

FIG. 7 is a drawing showing a first example of a system according to a second embodiment of the present invention.

### DESCRIPTION OF THE PREFERRED EMBODIMENTS

Referring to drawings, the preferred embodiments of the present invention will be explained in detail hereinafter.

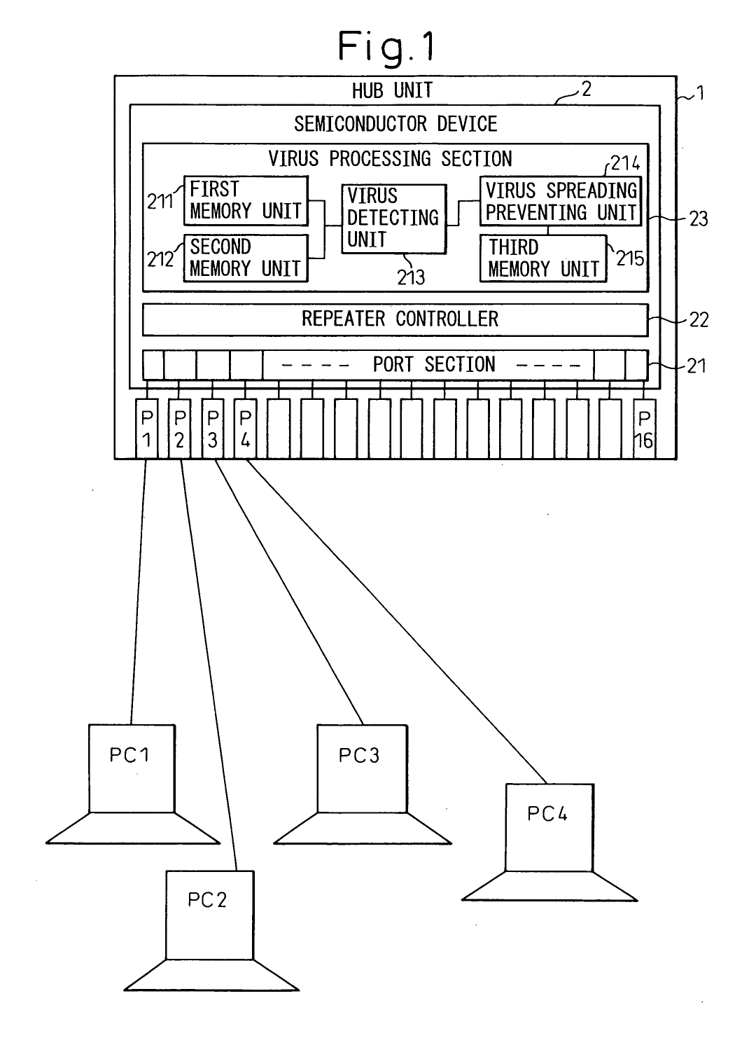

FIG. 1 is a drawing showing a general structure of a hub unit having a function of preventing the spread of viruses according to a first embodiment of the present invention. The hub unit 1 as shown in FIG. 1 is simply called a hub conforming to the 10 BASE-T defined by the IEEE 802.3 standard. In general, the 10 BASE-T hub unit is provided with a plurality of physical ports, for example 8 ports, 16 ports or the like, which connect network devices by means of a star topology. Herein, the network devices mean computers such as personal computers, work stations, gateways, routers and the like, and other hub units.

The hub unit 1 is provided with 16 ports, has a relay function that receives data from PC1 connected to port No. 1 and transmits the data to PCs connected to all ports but port No. 1, namely PC2 to PC16 connected to the corresponding port Nos. 2 to 16, or to a PC of which transmission address is attached to the data. In this connection, not all of ports No. 1 to No. 16 need be used. FIG. 1 shows an example of a hub unit 1 having 16 ports and connecting only four network devices, for example PC1 to PC4. By the way, even though network devices are connected to the ports, for example port No. 1 to No. 4, by electrical cables, there is a case that some of the network devices, for example devices connected to port No. 3 and No. 4, are inactive because of the power failure or the like. Even in this case, the hub unit 1 outputs data received from port No. 1 to ports other than port No. 1, namely port No. 2 to No. 16.

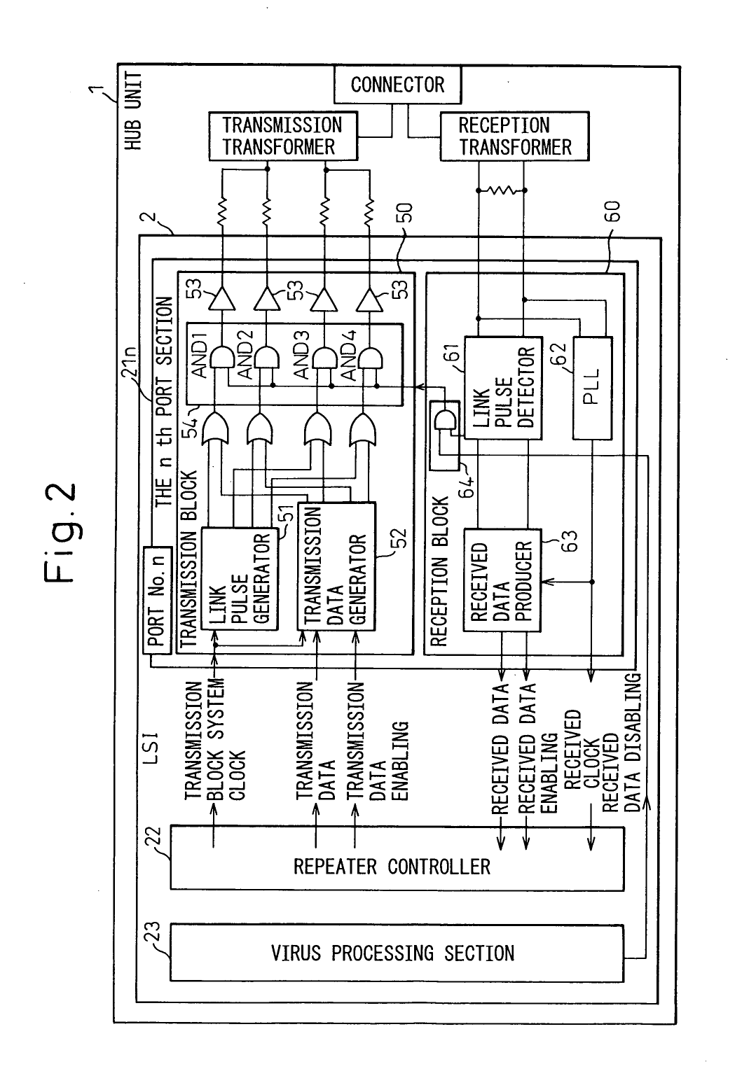

The hub unit 1 includes a semiconductor device (LSI) 2 connected to ports No. 1 to No. 16. The LSI 2 includes a port section 21 connected to the ports No. 1 to No. 16, a repeater controller 22 and a virus processing section 23. The port section 21 and the repeater controller 22 will be explained later, referring to FIGS. 2 to 4.

The virus processing section 23 includes a first memory unit 211, a second memory unit 212, a virus detecting unit 213, a unit 214 for preventing the spread of viruses and a third memory unit 215. The first memory unit 211 stores information of virus patterns. The second memory unit 212 temporarily stores a packet received from a certain network device or a computer. The virus detecting unit 213 compares the virus patterns stored in the first memory unit 211 with a packet temporarily stored in the second memory unit 212 and determines whether the packet is infected with a virus or not. The virus spreading preventing unit 214 interrupts the transmission of the packet to network devices connected to the hub unit 1 other than said certain network device when the virus detecting unit 213 determines that the packet is infected with a virus. The third memory unit 215 stores transmission addresses, so called MAC addresses, of network devices, or computers, connected to the ports. Herein, the MAC address is an address to distinguish a computer connected to a physical network in which a LAN board is installed, which is required in a communication network, for example a LAN such as an Ethenet (Trademark).

The virus spreading preventing unit 214 may be designed to operate in the following way. That is, the unit 214, when the virus detecting unit 213 determines that a packet is infected with a virus, determines whether a transmission computer address attached to the packet coincides with at least one of addresses stored in the third memory unit 215 and, if these addresses coincide, the unit 214 does not transmit the packet to the one or more corresponding computers.

The virus processing section 23 is comprised of a general digital computer, which includes a CPU, a RAM, a ROM, an input port, an output port and the like, mutually connected via a bi-directional bus (not shown).

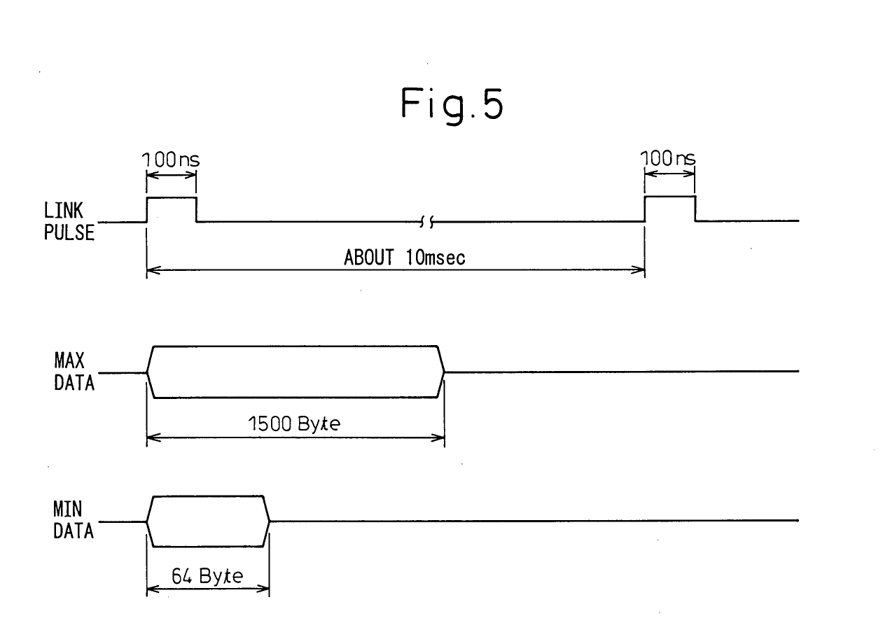

FIGS. 2 to 4 are drawings respectively showing first, second and third examples of a hub unit according to the present invention. FIG. 5 is a time chart showing a link pulse and communication data. The hub unit 1 according to the first to the third embodiments, as shown in FIGS. 2 to 4, includes a semiconductor device (LSI) 2, resistors, a transformer for data transmission, a transformer for data reception and a connector. The connector corresponds to each port as shown in FIG. 1 and is provided for connecting personal computers for example PC 1 to PC4 to the hub unit 1, as can be seen from FIG. 1. The LSI 2 includes “n” port sections altogether wherein “n” equal 16 in this embodiment and “port n” indicates the n-th port section 21n. The LSI 2 also includes a repeater controller 22 and a virus processing section 23. The n-th port section 21n includes a transmission block 50 and a reception block 60. The resistors, the transmission transformer, the reception transformer and a connecter are respectively provided for each n-th port section 21n.

The transmission block 50 includes a link pulse generator 51, a transmission data generator 52, a plurality of drivers 53 and a power saver 54. The link pulse generator 51 receives a transmission block system clock signal, hereinafter simply refers to the transmission clock, having 10 MHz frequency in this embodiment, transmitted from the repeater controller 22, and generates a link pulse signal as shown at the upper part in FIG. 5. Herein, the link pulse is a signal having a pulse, of which the width is 100 ns, output every 10 msec, as shown in FIG. 5. This link pulse is defined in IEEE 802.3 standard.

The transmission data generator 52 receives a transmission clock output from the repeater controller 22, a transmission data signal and a transmission data enable signal which indicates that the transmission data is valid with a high level. The transmission data signal can be from 1,500 byte data at the maximum to 64 byte data at the minimum, as shown at the middle and the lower parts in FIG. 5. The generator 52 generates transmission data to be output from the hub unit 1. Herein, the transmission data is transmitted at the rate of 100 nsec/bit. Therefore, the time required to transmit the data is about 0.05 msec at the minimum and is about 1.2 msec at the maximum, wherein 0.05 msec is given by 64×8×100 (ns) and 1.2 msec is given by 1500×8×100 (ns). The driver 53 amplifies and outputs the transmission data signal.

The power saver 54 is provided for interrupting outputs from the drivers 53 and for reducing the power consumption of the transmission block 50. AND gates AND1 to AND4 that compose the power saver 54 are controlled based on link information detected by a link pulse detector 61 in the reception block 60. If the result of the detection by the detector 61 is inactive, namely the output level of the detector 61 is low, all of the AND gates in the saver 54 become low level. As a result, if the state of a port P-n (n=1 to 16) connected to a port section 21n is determined as inactive by the link pulse detector 61, the current output from a transmission block 50 corresponding to a port section 21n in which an inactive network device is connected, can be reduced and, thereby, power consumption can be reduced. The reception block 60 will be explained hereinafter.

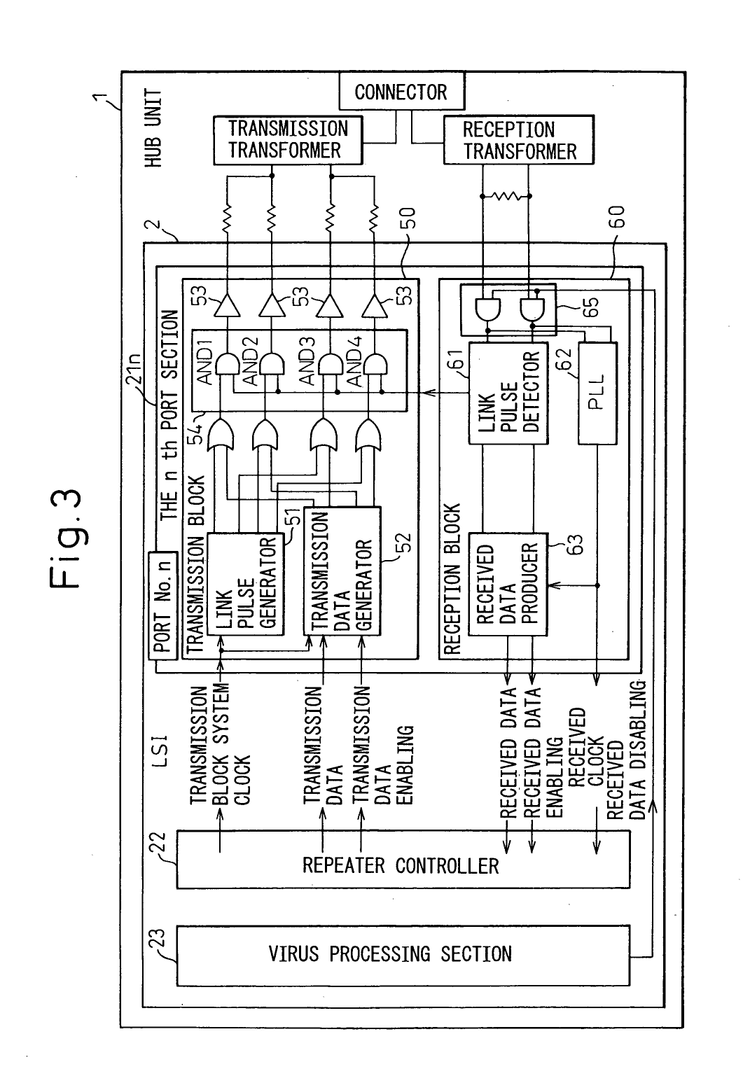

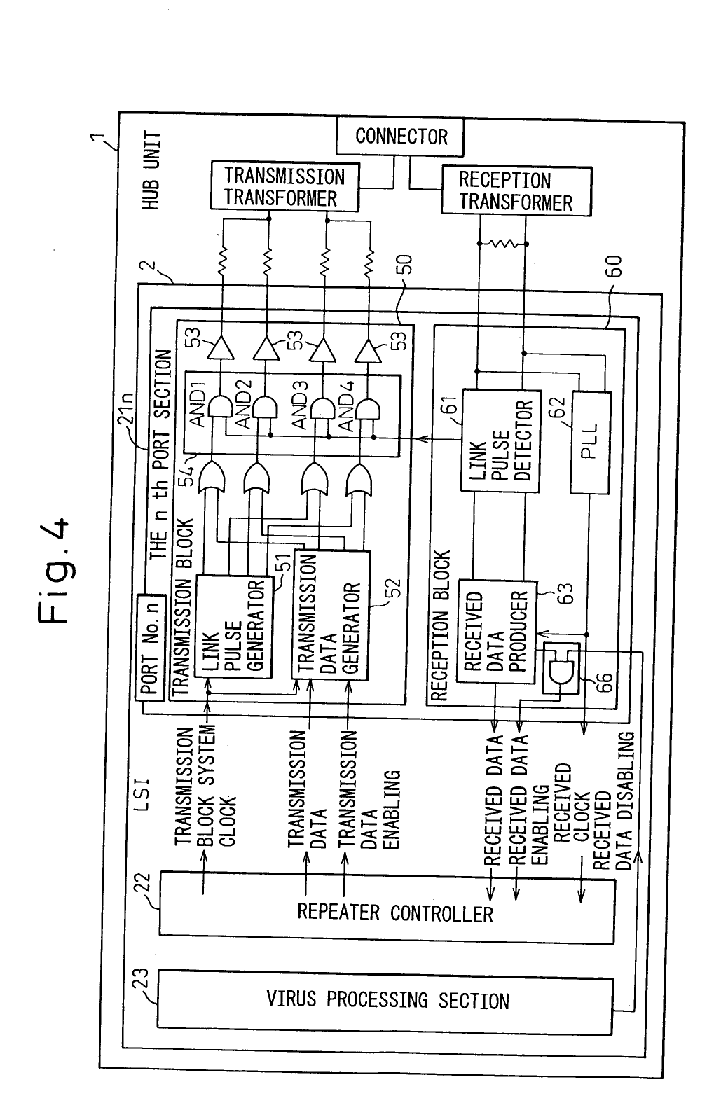

The reception block 60 includes a link pulse detector 61, a phase locked loop (PLL) 62, a received data reproducer 63 and a transmission interrupter 64 as shown in FIG. 2. Other transmission interrupters 65 and 66 are respectively shown in FIGS. 3 and 4. The link pulse detector 61 controls AND gates AND1 to AND4 composing the power saver 54, based on link information received from the reception transformer via the corresponding port. If the result of the detection by the detector 61 is inactive, namely the output level of the detector 61 is low, all of the AND gates in the saver 54 become low level. The PLL 62 generates a received clock signal from the data received from the reception transformer via the corresponding port.

The received data reproducer 63 receives data from the link pulse detector 61 and the received clock signal from the PLL 62, reproduces the received data and generates a received data enabling signal which becomes a high level when the received data is valid. The transmission interrupters 64 to 66 are connected to an output port in the virus spreading out preventing unit 214 that interrupts the transmission of a packet to network devices other than said certain network device, or the computer, connected to the hub unit 1 when the virus detecting unit 213 in the virus processing section 23 determines that the packet is infected with a virus. This output port is provided for sending a received data disabling signal to the transmission interrupters 64 to 66, wherein the signal is at a high level before detecting a virus infection and becomes low level when a virus infection is detected.

The virus spreading preventing unit 214 according to a second and a third embodiments is designed not to receive a new packet from said certain network device by means of the transmission interrupter 65 of the second embodiment and the transmission interrupter 66 of the third embodiment, after the virus detecting unit 213 detects a packet infected with a virus. The unit 214 may also be designed not to transmit the packet to other network devices if it detects an infected packet.

The virus spreading preventing unit 214 according to the third embodiment is designed to invalidate a packet newly received from said certain network device by means of the transmission interrupters 66 after the virus detecting unit 213 detects a packet infected with a virus.

The hub unit 1 according to the first to third embodiments includes a display (not shown) indicating that an infected packet is detected when the virus detecting unit 213 determines that a packet is infected with a virus. Users of the network device, for example a computer, can recognize that a virus infection occurred from this display.

The repeater controller 22 receives a received data signal, a received data enabling signal and a received clock signal from any one of port 21-i among the n ports {21-1 to 21-n}, and respectively transmits a transmission system clock signal, a transmission data signal and a transmission data enabling signal to all of the other (n-1) ports {21-1 to 21-(i−1) and 21-(i+1) to 21-n} except 21-i.

Incidentally, when the n-th port 21-n receives a packet during transmission signals a collision occurs in which transmission and reception occurs simultaneously. In this case, the repeater controller 22 executes the following collision process.

First, a specific data signal called a jam signal is transmitted to all of ports for a predetermined period. In addition, one or more PCs such as PC1 and PC2 which caused the collision, transmit the jam signal for a predetermined period by means of their network interface card. After the jam signal is transmitted, all of the hub unit 1 and the PCs stop transmission of the jam signal. Then, after waiting a random period, the PC1 and PC2 which caused the collision, restart to transmit a packet.

Next, the transmission interrupters 64 to 66 in the reception block 60 will be explained in detail below.

The transmission interrupter 64 according to the first embodiment as shown in FIG. 2, is comprised of a single AND gate, wherein an output lead of the link pulse detector 61 in the reception block 60 which outputs a control signal is connected to one input lead of the AND gate, and an output lead of the virus spreading preventing unit 214 in the virus processing section 23 which outputs a received data disabling signal is connected to another input lead of the AND gate. The output lead of the AND gate in the interrupter 64 is connected to each input lead of the AND gates, AND1 to AND4, in the power saver 54 in the transmission block 50. The received data disabling signal changes its level from high to low when the virus detecting unit 213 in the virus processing section 23 in the hub unit 1 determines that a packet is infected with a virus. This disables transmission of the infected packet to all of the network devices connected to the hub unit 1 except for the network device that transmitted the infected virus.

The transmission interrupter 65 according to the second embodiment, as shown in FIG. 3, is comprised of dual AND gates, wherein an output lead of a reception transformer, in the hub unit 1, which outputs a received signal is connected to an input lead of each AND gate, and an output lead of the virus processing section 23 which outputs a receive data disabling signal is connected to another input lead of each AND gate. The output leads of the AND gates in the interrupter 65 are connected to input leads of the link pulse detector 61 in the reception block 60. The received data disabling signal is output from the virus spreading preventing unit 214 in the virus processing section 23. The disabling signal changes its level from high to low when the virus detecting unit 213 in the virus processing section 23 in the hub unit 1 determines that a packet is infected with a virus. This disables reception of new packets from the network device, connected to the hub unit 1, that transmitted the infected virus.

The transmission interrupter 66 according to the third embodiment, as shown in FIG. 4, is comprised of a single AND gate, wherein an output lead of the receiving data reproducer 63 in the reception block 60 which outputs a received data enabling signal is connected to one input lead of the AND gate, and an output lead of the virus processing section 23 which outputs a received data disabling signal is connected to another input lead of the AND gate. The output lead of the AND gate in the interrupter 66 is connected to an input lead of the repeater controller 22. The received data disabling signal is output from the virus spreading preventing unit 214 in the virus processing section 23. The disabling signal changes its level from high to low when the virus detecting unit 213 in the virus processing section 23 in the hub unit 1 determines that a packet is infected with a virus. This invalidates to transmit new packets entered from the network device, connected to the hub unit 1, that transmitted the infected virus.

Next, a method for making the hub unit 1 return to the normal state will be described below. As explained above, when the hub unit 1 detects that a packet is infected with a virus, it operates to not transmit the packet outside the unit 1 by changing the level of the received data disabling signal from high to low, in order to avoid a secondary infection. When such a virus infection is detected, the user is notified by an indicator (not shown) mounted on a body of the unit 1. Then, the user depresses a push button (not shown) mounted on the body to reset the abnormal state and return to the normal state. This reset function is provided in the virus spreading preventing unit 214 in the virus processing section 23 in the hub unit 1.

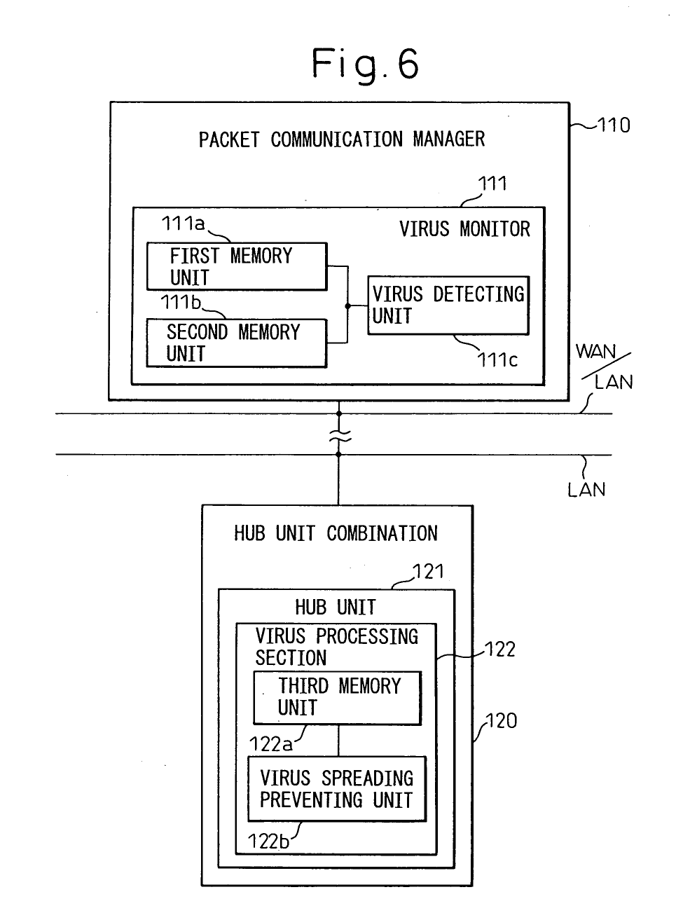

FIG. 6 is a block diagram showing a structure of a system for preventing the spread of viruses according to a second embodiment of the present invention. The virus spreading preventing system 100 as shown as a whole in FIG. 6 includes a packet communication manager 110 and a hub unit combination 120. The packet communication manager 110 is connected to the hub unit combination 120 via a LAN after passing through a WAN/LAN. The packet communication manager 110 is provided with a virus monitor comprised of, for example a gateway or a router. In the manager 110, there is provided a first memory unit 111a storing patterns of viruses, a second memory unit 111b temporarily storing a packet received from a certain network device, and a virus detecting unit 111c that compares the virus patterns stored in the first memory unit 111a with the packet temporarily stored in the second memory unit 111b, and determines whether or not the packet is infected with the virus.

Herein, the gateway is a device that carries out a function as an application layer, while the router is a device that carries out a function as a network layer in a basic model of OSI (Open Systems Interconnection). The OSI is a network architecture that allows communications between different kinds of computers. The architecture is composed of a first layer that is a physical layer, a second layer that is a data link layer, a third layer that is a network layer, a fourth layer that is a transport layer, a fifth layer that is a session layer, a sixth layer that is a presentation layer and a seventh layer that is an application layer.

The hub unit combination 120 includes at least one hub unit 121 which is the same hub unit 1 as that explained referring to FIGS. 1 to 4. The hub unit 121 includes a virus processing section 122 including a third memory unit 122a that stores transmission addresses of computers connected to the hub unit 121 and a virus spreading preventing unit 122b that receives address information of a computer from the packet communication manager 110, when the virus detecting unit 111c in the manager 110 determines that the packet transmitted from the computer is infected with a virus, and that prevents the hub unit 121 transmitting the packet to all of the computers other than the computer which transmitted the infected packet.

The virus spreading preventing unit 122b receives address information, from the packet manager 110, of a computer transmitted a packet to the hub unit 121 when the virus detecting unit 111c in the manager 110 determines that the packet is infected with a virus. The unit 122b determines whether the address information attached to the packet, of the computer that transmitted the packet infected with a virus coincides with an address stored in the third memory unit 122a, and disables transmission of the packet to the computer having the transmission address if coincidence is determined.

In the hub unit combination 120, a plurality of hub units 121 are connected in a cascade form. The virus spreading preventing section 122b receives address information, from the packet communication manager 110, on a computer transmitting a packet, when the virus detecting unit 111c in the packet communication manager 110 determines that the packet is infected with a virus. Then, the preventing section 122b determines whether or not the address information attached to the packet coincides with an address stored in the third memory unit 122a. If coincidence is not determined, the preventing section 122b in the successive hub unit 121 checks the coincidence in the same manner. If the coincidence is determined, the packet transmission to the computer having the coincident transmission address is disabled.

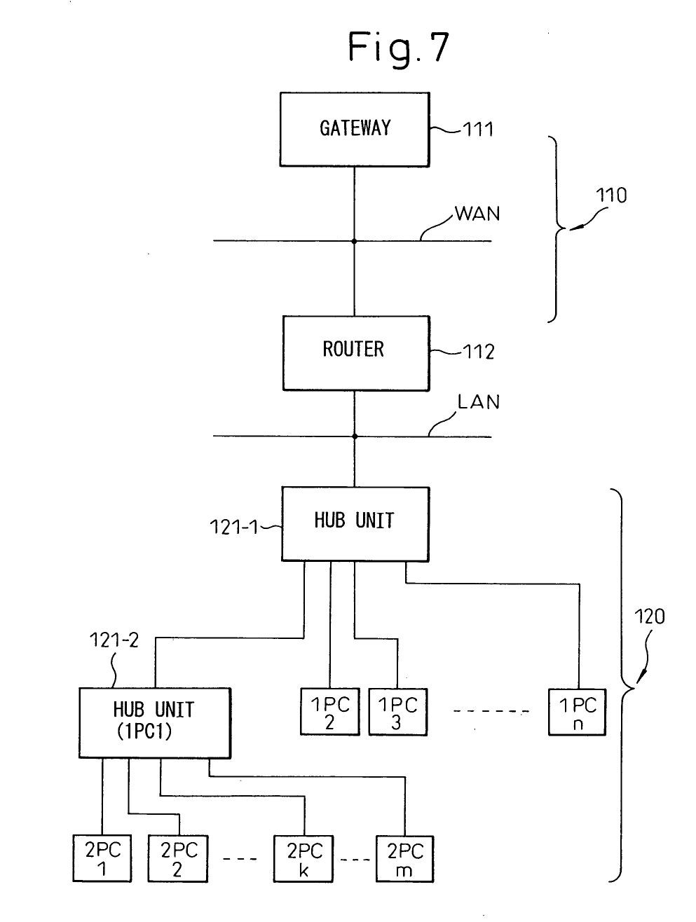

FIG. 7 is a drawing showing a first example of a system according to a second embodiment of the present invention. In this system, by referring to FIGS. 6 and 7, it should be understood that the packet communication manager 110 is a gateway 111 and the hub unit combination 120 includes two hub units 121-1 and 121-2. The hub unit 121-1 is connected to a hub unit 1PC1 as a network device and (n-1) of computers 1PC2 to 1PCn one of which is a router 112. In a third memory unit in a virus processing unit, not shown, in the hub unit 121-1, MAC addresses of computers 1PC2 to 1PCn are stored. The hub unit 121-2 is connected to (m) of computers such as 2PC1, 2PC2, . . . , 2PCk, . . . , and 2PCm, as network devices. In a third memory unit in a virus processing unit in the hub unit 121-2, MAC addresses of computers 2PC1, 2PC2, . . . , 2PCk, . . . , and 2PCm are stored. Herein, k, n and m are positive integers, andk<n, k<m. For example, if the computer 2PCk is the transmission destination of the virus infected packet, in the hub unit according to the first embodiment, data transmission from the k-port 21k connected to the port Pk in the hub unit 122-2 is disabled, whereby the packet infected with the virus cannot be output outside the hub units 122-1 and 122-2. On the other hand, according to the second and the third embodiments, the received data at the k-port 21k connected to the port Pk in the hub unit 122-2 is invalidated, whereby the packet infected with the virus cannot be output outside the hub units 122-1 and 122-2.

In the virus spreading preventing system as shown in FIG. 7, the packet communication manager has been explained as a gateway 111, but the manager 110 may be a router.

As explained hereinabove, according to the present invention, a hub unit and a virus spreading preventing system each provided with a virus spreading preventing function that can protect the unit and the system from virus invasion, without providing virus invasion preventing measures, and can prevent a second infection with the virus.

What is claimed is:

1. A hub unit connected to a plurality of communication devices, which controls transmission and reception of data between the devices, comprising:
a first memory unit storing virus pattern information;
a second memory unit temporarily storing data received from any one of the communication devices;
a virus detecting unit that determines whether the data temporarily stored in the second memory unit is infected with a virus or not based on the virus patterns stored in the first memory unit; and
a virus spreading preventing unit that disables transmission of the data outside the hub unit when the detecting unit determines that the data is infected with a virus.

2. A hub unit according to claim 1, further comprising a third memory unit storing transmission addresses of the plurality of the communication devices, wherein when the detecting unit determines that data is infected with a virus, the virus spreading preventing unit registers a transmission address of a communication device that transmitted the data to the hub unit.

3. A hub unit according to claim 1, wherein the virus spreading preventing unit disables transmission of newly received data from a first communication device which transmits data infected with a virus, to the other communication devices, after the detecting unit determines that the data transmitted from the first communication device is infected with a virus.

4. A hub unit according to claim 1, wherein the virus spreading preventing unit disables to reception of new data from a first communication device which transmits data infected with a virus, after the detecting unit determines that the data transmitted from the first communication device is infected with a virus.

5. A hub unit according to claim 1, wherein the virus spreading preventing unit invalidates data newly received from a first communication device which transmits data infected with a virus, after the detecting unit determines that the data transmitted from the first communication device is infected with a virus.

6. A hub unit according to claim 1, further comprising a display unit for notifying that data is infected with a virus if the detecting unit determines that the data is infected with a virus.

7. A system for preventing the spread of viruses in a communications network, comprising at least a hub unit connected to a plurality of communication devices, which controls transmission and reception of data between the devices and a monitor connected to the hub unit via the network, which monitors communication between the devices, wherein
said monitor comprises:
a first memory unit storing virus pattern information,
a second memory unit temporarily storing data received from any one of the communication devices, and
a virus detecting unit that compares virus patterns stored in the first memory unit with the data temporarily stored in the second memory unit, and determines whether the data is infected with a virus or not, and
said hub unit comprises:
a third memory unit storing transmission addresses of the plurality of the communication devices, and
a virus spreading preventing unit that receives a transmission address of a communication device that transmitted data to the hub unit when the detecting unit determines that the data is infected with a virus, and disables transmission of the data to communication devices other than the communication device that transmitted the data infected with the virus.

8. A system according to claim 7, wherein said virus spreading preventing unit determines whether or not a transmission address of a communication device, attached to data transmitted from the device, coincides with an address stored in the third memory unit, when the virus detecting unit determines that the data is infected with a virus and, if it determines that there is a coincidence between the two addresses, it disables transmission of the data to a communication device having the same address.

9. A system according to claim 7, wherein the virus spreading preventing unit disables reception of data newly transmitted from the communication device which transmits data infected with a virus, after the detecting unit determines that the data is infected with the virus.

10. A system according to claim 7, wherein the virus spreading preventing unit invalidates data newly received from the communication device which transmits data infected with a virus, after the detecting unit determines that the data is infected with the virus.

11. A system according to claim 7, further comprising a display unit for notifying that data is infected with a virus when the detecting unit determines that the data is infected with the virus.

12. A system according to claim 7, wherein a plurality of hub units are connected in a cascade form, and said virus spreading preventing unit determines whether or not a transmission address of a communication device, attached to data transmitted from the device, coincides with an address stored in the third memory unit in a first hub unit among the plurality of the hub units, when the virus detecting unit determines that the data is infected with a virus, and if it determines that there is no coincidence between the two addresses it successively checks for the coincidence between the transmission address and addresses stored in the respective third memory units in the successive hub units, and if it determines that there is a coincidence between two addresses it disables transmission of the data to a communication device having the same address.

13. A system according to claim 7, wherein said monitor is a gateway.

14. A system according to claim 7, wherein said monitor is a router.

15. A computer program for a method of preventing the spread of viruses in a communications network wherein a hub unit connected to a plurality of communication devices controls transmission and reception of data between the devices, the program makes the computer execute the steps of:
storing virus pattern information in a first memory unit;
temporarily storing data received from any one of the communication devices in a second memory unit;
determining whether the data temporarily stored in the second memory unit is infected with a virus, or not, based on the virus patterns stored in the first memory unit; and
disabling transmission of the data outside the hub unit when it is determined that the data is infected with a virus in the detecting step.

16. A computer program according to claim 15, the program makes the computer execute the further steps of:
storing transmission addresses of the plurality of the communication devices in a third memory unit, and
registering a transmission address of a communication device that transmitted data to the hub unit when it is determined that the data is infected with a virus in the detecting step.

17. A method of preventing the spread of viruses in a communications network wherein a hub unit connected to a plurality of communication devices controls transmission and reception of data between the devices, comprising the steps of:
storing virus pattern information in a first memory unit;
temporarily storing data received from any one of the communication devices in a second memory unit;
determining whether the data temporarily stored in the second memory unit is infected with a virus, or not, based on the virus patterns stored in the first memory unit; and
disabling transmission of the data outside the hub unit when it is determined that the data is infected with a virus in the detecting step.

18. A method according to claim 17, comprising the further steps of:
storing transmission addresses of the plurality of the communication devices in a third memory unit, and
registering a transmission address of a communication device that transmitted data to the hub unit when it is determined that the data is infected with a virus in the detecting step.
